(19) United States
(12) Patent Application Publication
(10) Pub. No.: US 2019/0371059 A1
(43) Pub. Date: Dec. 5, 2019

(54) METHOD FOR CREATING A THREE-DIMENSIONAL VIRTUAL REPRESENTATION OF A PERSON

(71) Applicant: My Eggo, Paris (FR)

(72) Inventor: Karim Toubal, Paris (FR)

(21) Appl. No.: 16/478,451

(22) PCT Filed: Jan. 17, 2018
(86) PCT No.: PCT/FR2018/050114

§ 371 Date: Jul. 16, 2019

(30) Foreign Application Priority Data
Jan. 17, 2017 (FR) 1750342

(51) Int. Cl. G06T 17/20; G06T 13/40; G06T 7/68

(52) U.S. Cl. CPC G06T 17/205; G06T 13/40; G06T 2207/10028; G06T 2200/08; G06T 2200/04; G06T 7/68

(57) ABSTRACT

A method for creating a three-dimensional virtual representation of a person, comprising the steps of: a) acquiring a plurality of images of a person located in a reference position in an imaging cabin and, b) calculating, by photogrammetry, a crude mesh of the actual person. The step of acquiring the plurality of images consists of recording a series of at least twenty-four simultaneous images coming from image sensors distributed across the inner surface of a closed ovoid-shaped cabin provided with an access door, the image sensors being distributed in a homogeneous manner with respect to the axis of symmetry of the cabin.

### CROSS-REFERENCE TO RELATED APPLICATIONS

This application is a national phase entry under 35 U.S.C. § 371 of International Patent Application PCT/FR2018/050114, filed Jan. 17, 2018, designating the United States of America and published in French as International Patent Publication WO 2018/134521 A1 on Jul. 26, 2018, which claims the benefit under Article 8 of the Patent Cooperation Treaty to French Patent Application Serial No. 1750342, filed Jan. 17, 2017.

### TECHNICAL FIELD

This disclosure relates to the field of virtual reality and more specifically the creation of three-dimensional photorealistic digital representations from a series of images of a human person and using photogrammetry techniques.

### BACKGROUND

3D body scanning (also called 3D body scan, or full 3D scan) makes it possible to scan the body of a subject using equipment sometimes referred to as a “3D body scanner”.

Just as a photograph captures a person's image in two dimensions, a 3D scanner records the shape of the body in three dimensions. The result is a 3D file (also called a 3D model) that can then be stored in or modified on a computer, and potentially sent to a 3D printer for production.

The sectors that mainly use 3D scanning of the human body are gaming, medicine and fashion to create stationary or animated avatars or to manufacture, for example, realistic figures of people.

Two technologies are mainly used for 3D body scanning: photogrammetry, which uses the reconstruction of 3D volumes from traditional photographs; and structured light, based on the deformation of projected light, which thus makes it possible to calculate the distance, and therefore the position of the body's points.

This disclosure is part of the first family of solutions, implementing processing by photogrammetry.

### STATE OF THE ART

European patent EP1322911 describes a solution for acquiring a three-dimensional representation of a human body. The image sensor used for the shooting is complemented by additional light pattern projectors that are attached to the body and project simple geometric structures such as points and lines onto the body. These structures visible without the viewfinder image facilitate the manual orientation of the image sensor and the positioning of the image sensor at the correct distance from the body when taking the many overlapping individual images required for photogrammetric evaluation. This manually predetermined orientation facilitates the automatic assignment of photogrammetric marks to individual pairs of images by means of image treatment processes and allows this automated assignment to be carried out more safely. In a preferred embodiment of the disclosure, the projectors are switched off during the actual shooting.

US patent application US2012206587 describes a skin surface imaging system for capturing at least one image of the skin of a patient's body, comprising a base and a plurality of image sensors that can be connected to the base, arranged in a predetermined arrangement. Each image sensor captures the image of a predetermined area of the body. These sensors provide a series of images. A processing unit communicates with the image sensors to:
(i) collect the set of images coming from the image sensors;
(ii) analyze the set of images; (iii) record personal data associated with the patient's body skin.

International patent application WO 2012110828 describes a method for creating a virtual body model of a person, created from a small number of measurements and a single photograph, combined with one or more images of clothes. The virtual body model provides a realistic representation of the user's body and is used to visualize photorealistic adjustment visualizations of clothes, hairstyles, make-up, and/or other accessories. Virtual clothes are created from layers based on photographs of actual clothes taken from several angles. In addition, the virtual body model is used in many embodiments of manual and automatic recommendations for clothes, make-up, and hair, for example, from channels, friends, and fashion entities. The virtual body model can be shared, for example, for visualization and style comments. In addition, it is also used to allow users to purchase clothing that fits other users, which may be suitable as gifts or the like. The implementation can also be used in peer-to-peer on-line sales where clothing can be purchased knowing that the seller's body shape and size are similar to those of the user.

Solutions known in the art are not fully satisfactory.

Some solutions employ a moving image sensor moving around the subject. If the subject moves during the image acquisition phase, photogrammetry processing is disrupted.

Other solutions require the use of markers or structured areas, which requires a subject preparation step and does not allow a photorealistic image to be acquired.

Still other solutions provide for the acquisition of images from image sensors, but do not provide satisfactory quality through a single acquisition in natural light.

### BRIEF SUMMARY

The present disclosure, in its broadest sense, relates to a method for creating a three-dimensional virtual representation of a person comprising the following steps:
a) acquiring a plurality of images of a person located in a reference position in an imaging cabin, and
b) calculating, by photogrammetry, a crude mesh of the actual person,
characterized in that the step of acquiring the plurality of images involves recording a series of at least eighty simultaneous images, and preferably at least one hundred simultaneous images, coming from image sensors distributed across the inner surface of a closed ovoid-shaped cabin provided with an access door, the image sensors being distributed in a homogeneous manner with respect to the axis of symmetry of the cabin.

For the purposes of this disclosure, the term “image sensor” means a still image sensor equipped with optics for shooting images in natural light.

A preferred “reference position” would be a position in which the person preferably has a straight posture, with the arms slightly apart from the body, the fingers slightly apart, the feet also apart from each other at a predefined distance (advantageously by means of marks on the floor of the cabin), with the eyes turned toward the horizon and a neutral facial expression.

By providing for a simultaneous acquisition of images of the person located in the reference position in an ovoid-shaped cabin using a minimum number, i.e., at least eighty, sensors, a precise and complete reconstructed image of the person located in the cabin can be generated.

In addition to contributing to the accuracy of the reconstruction of the image of the person in the reference position, the ovoid shape of the cabin also ensures optimal positioning and orientation of the sensors, which are aimed directly at the person, regardless of their height and build. Preferably, the photosensitive surface of the image sensors is smaller than 25×25 millimeters. Using at least eighty thus dimensioned sensors has the advantage of optimizing the volume of the cabin and thus achieving an optimal size of the latter.

Preferably, the inner surface of the cabin has non-repetitive contrast patterns, the method comprising at least one step of calibration that includes acquiring a session of images of the cabin without a person being present, the step of photogrammetry comprising a step of calculating an ID image by subtracting the acquired image in the presence of a person in the cabin and the calibration image corresponding to the same image sensor.

Advantageously, the step of photogrammetry includes the steps of creating a cloud of 3D points by extracting, in each of the close-cut images IDᵢ of the characteristic points PCᵢⱼ and recording the coordinates of each of the characteristic points PCᵢⱼ and building the crude mesh from the characteristic points PCᵢⱼ thus identified and calculating the envelope texture.

According to an alternative solution, the 3D mesh and texturing are subjected to an additional smoothing treatment.

According to another alternative solution, the method includes an additional step of merging the crude mesh with a model mesh MM organized in groups of areas of interest corresponding to subsets of polygons corresponding to significant parts, to be determined on the crude mesh corresponding to the singular points previously identified on the model mesh MM, and then applying a treatment including deforming the mesh of the model MM to locally match each singular point with the position of the associated singular point on the crude mesh MBI, and recalculating the position of each of the characteristic points of the mesh of the model MM.

Advantageously, the step of transforming the crude mesh into a standardized mesh comprises the automatic identification of a plurality of characteristic points of the human body on the crude mesh, by processing for the recognition of elements recorded in a library of points of interest in a table form associating a digital label with a characterization rule.

The disclosure also relates to an image shooting cabin comprising a closed structure having an access door, including a plurality of image sensors oriented toward the inside of the cabin, characterized in that the cabin has an ovoid inner shape having at least eighty image sensors, and preferably one hundred image sensors, distributed over the inner surface of the ovoid shape in a homogeneous manner with respect to the axis of symmetry of the cabin.

Preferably the cabin has a maximum median cross section between 2 and 5 meters, and preferably less than 2 meters.

### BRIEF DESCRIPTION OF THE DRAWINGS

This disclosure will be better understood when reading the following detailed description thereof, which relates to a non-restrictive exemplary embodiment, while referring to the appended drawings, wherein:

FIG. 1 is a schematic view of a cabin for acquisition by photogrammetry; and

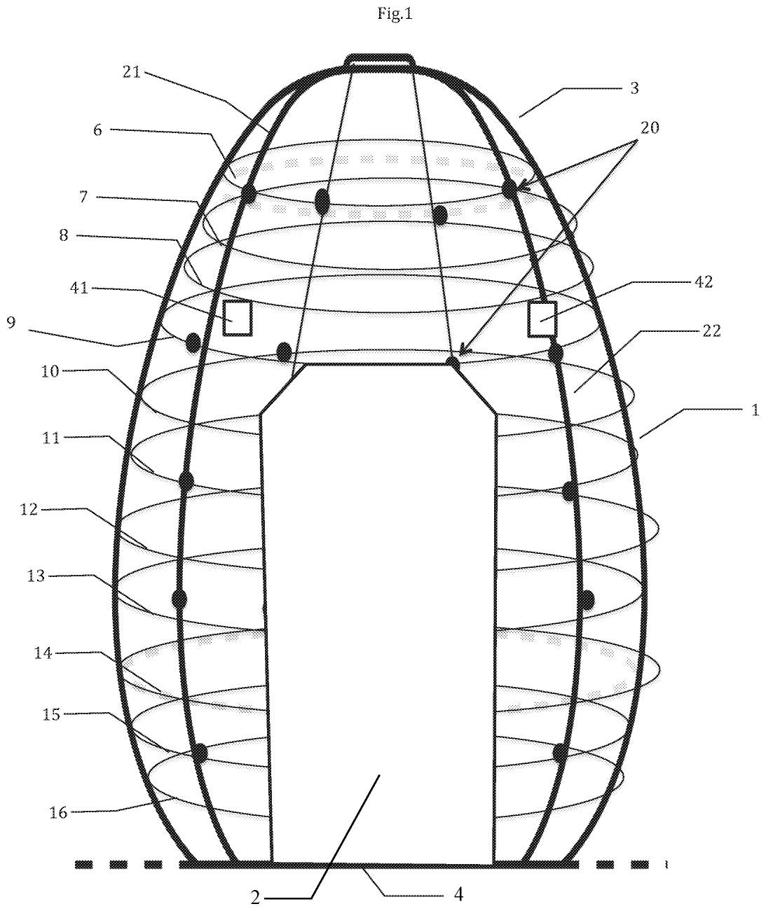

FIG. 2 is a schematic view of the hardware architecture of a system for implementing embodiments of the present disclosure.

### DETAILED DESCRIPTION

The implementation of this disclosure involves a first step of acquiring images of an actual person.

For this purpose, a cabin includes a group of image sensors 20, located on a generally ovoid-shaped envelope surrounding the person.

The height of the cabin is about 250 centimeters, and the maximum inside diameter is about 200 centimeters.

The cabin comprises an ovoid wall 1 having a circular cross-section, an opening through a door 2, and is extended at its upper part 3 by a hemispherical cap and closed at its lower part by a floor 4.

The cabin thus defines a surface of revolution, the generator of which has a curved section that surrounds the person whose image sequence is being created.

This surface of revolution supports the image sensors 20, which are distributed evenly to form overlaps of their fields of view. The image sensors 20 are stationary relative to the support and the person.

In the example described, the cabin has two hundred and sixty (260) image sensors 20, divided into about ten transverse strata 6 to 16. The spacing between two strata varies, with the spacing between two consecutive strata being greater for the middle strata 11 to 13 than for the upper strata 6 to 10 or lower strata 13 to 16 strata. The image sensors 20 may be high definition (8 MB) sensors.

The number of image sensors 20 is preferably greater than 100, evenly distributed across the inner surface of the cabin except for the surfaces corresponding to the door and the floor.

The layers 10 to 16 cut by the door 2 have twenty image sensors distributed evenly at an angle, except at the door 2.

The strata 8 and 9 have a larger number of image sensors 20, for example, 24, due to the absence of a door. The strata 6 and 7 with a smaller radius have a smaller number of image sensors 20.

The image sensors 20 are not necessarily aligned on the same longitudes, an angular distribution varying from one stratum to another, which allows for increased overlap of the areas of the fields of view of the sensors 20.

Each image sensor 20 is connected to a local electronic circuit comprising communication means and a computer running a program controlling:
the activation and deactivation of the associated image sensor;
optionally, the recording in a local memory of the acquired images and the buffering of the images from the associated image sensor;
the optical parameters of the image sensor such as the aperture, the sensitivity, the white balance, the resolution, the color balance, the shooting time; this check is based on data from a server common to all the image sensors 20, as well as local data captured by the associated image sensor;
the activation of a visual or audible alert associated with the local image sensor; and
the transmission of actual-time images or locally recorded images to a remote server.

The cabin has a dedicated server, including means of communication with the local maps of each of the image sensors, performing router functions and controlling the image sensors 20 based on data from a remote server.

The cabin also has light sources distributed over the inner surface of the cabin to provide omnidirectional and homogeneous lighting.

The light sources may include, for example, eight strips of LEDs 21, 22 arranged according to the longitudes of the cabin, distributed angularly and evenly, except at the door 2.

The light sources are optionally controlled by the dedicated server.

Optionally, the inner surface of the cabin has a uniform background with non-repetitive angular geometric contrast patterns, allowing the image sensor to be located by analyzing the background of the image.

Optionally, the cabin has an additional image sensor with a large shooting field, allowing the person to be viewed from the front, for transmitting an image of the person's position to an external operator during the image acquisition sequence.

The cabin also has loudspeakers 41, 42 distributed angularly around the head, to broadcast vocal instructions.

### Electronic Architecture

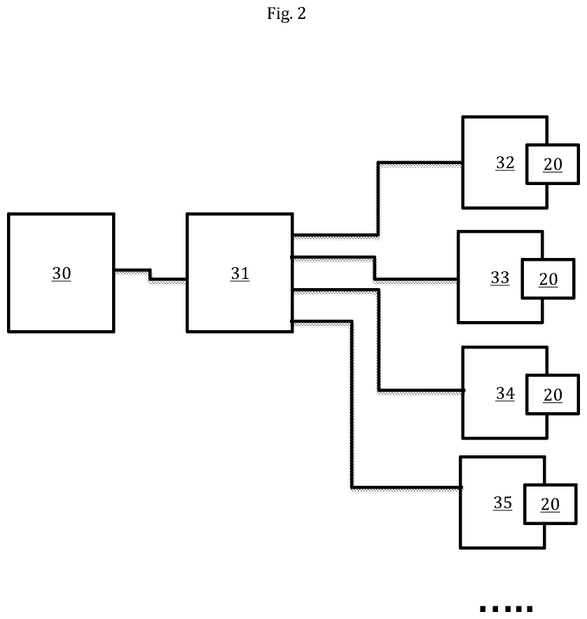

FIG. 2 shows a view of the electronic architecture in greater details;

The installation includes a central computer 30, communicating with the dedicated server 31 in the cabin. The dedicated server 31 communicates locally, in the cabin, with the local electronic circuits 32 to 35. Each of the local electronic circuits 32 to 35 has, for example, an image sensor 20 with a resolution of about 5 megapixels and a nominal aperture of f/2.8, a fixed focus length and a 42° H shooting field.

In addition, the installation includes network switches in the cabin, to prevent network collisions.

### Functional Architecture

The following description relates to an exemplary embodiment of the disclosure, comprising the following main steps:
acquiring the image of a person in the cabin and transferring the image to the computer performing the main processing;
photogrammetry;
first smoothing alternative for the creation of a photorealistic volume;
second alternative for recalculating the topology; and
creation of an avatar of the person.

Periodically, a calibration of the empty cabin, without any person being present, is carried out by acquiring a sequence of images of the structured surface of the cabin. This calibration makes it possible to recalculate the actual positioning of each of the image sensors 20 by analyzing the non-repetitive patterns on the inner surface of the cabin, and to record, for each of the image sensors in the background area, for further processing consisting in subtracting from the image acquired in the presence of a person, the image of the same area without any person being present.

### Acquisition of a Person's Image

When the person is located in the cabin, the following sequence of treatments is controlled.

A visual or audible alert indicates to the person that the shooting sequence has started, prompting the person to remain motionless until the end of the sequence alert.

Typically, the duration of the shooting sequence is less than one second.

Optionally, an infrared depth sensor, such as a 3D depth image sensor, monitors the person's position in the cabin, and automatically triggers the image acquisition sequence when the person is in the correct position, and otherwise triggers voice commands that tell the person about positioning errors, such as “raise your arm slightly” or “straighten your head” or “turn to the right” until the sensor detects that the person's position is in conformity with a nominal position.

The dedicated server 31 controls the cabin lighting, lowering the light level during the person's positioning phase, then increasing the light level during the image acquisition phase, and then lowering the light level again upon completion of the image acquisition phase. The dedicated server 31 can synchronously control sound effects associated with each of these phases, to help the person remain motionless during the image phase and monitor the process.

The dedicated server 31 controls, for the image acquisition phase, the simultaneous activation of all the image sensors 20 by transmitting an activation command to the local electronic circuits 32 to 35, then controls the transfer of the locally recorded data to the dedicated server 31 or to a remote computer. This transfer can be simultaneous or delayed to optimize the available bandwidth.

### Photogrammetry

The step of photogrammetry is applied to all the digital images coming from the image sensors 20, for example, 260 digital images acquired at the same time of the person located in the cabin.

The processing includes a first step of preprocessing each of the images Iᵢ (i being between 1 and 260 in the example described):
Creation of a close-cut image IDᵢ by subtracting the acquired image Iᵢ and the background image IFᵢ of the same area recorded during the calibration phase, and recording the pair of images (Iᵢ, IDᵢ);
Calculation of coordinates (Xᵢ, Yᵢ Zᵢ; Bᵢ Cᵢ, Dᵢ) or X,Y,Z corresponding to the coordinates of the image sensor in the cabin reference frame, A, B, C corresponding to the angular orientation (Euler angles) of the image sensor in the cabin reference frame and D is a binary parameter corresponding to the orientation of the image sensor on the axis predefined by the angles ABC, for each of the images Iᵢ and recording, for each of the pairs of images (Iᵢ, IDᵢ) the coordinates thus calculated. This calculation is performed, for example, with IGN's MicMac (trade names) or Visual SFM (trade name) software;
Creation of a cloud of 3D points by extracting the characteristic points PCᵢⱼ from each of the close-cut images IDᵢ and recording the coordinates of each of the characteristic points PCᵢⱼ; and
Construction of the crude mesh from the characteristic points PCᵢⱼ thus identified and calculation of the envelope texture.

The result of this step is a 3D mesh and an associated texture.

The 3D mesh MBI corresponding to the original person's crude mesh is saved in a common format, for example, OBJ, which is an exchange file format containing the description of a 3D geometry.

The texture is saved in a PNG image format.

### First Smoothing Alternative for Obtaining a Photorealistic Volume

For a first application, the 3D mesh and texturing thus calculated are subjected to an additional smoothing treatment.

This treatment involves removing noise in the unsmoothed 3D mesh, having a nil mesh size level, by reducing the resolution by a local average calculation applied to each of the characteristic points PCᵢᵢ and by assigning a normal orientation to each of these characteristic points PCᵢⱼ, to record a smoothed mesh as a combination of PCL_{1,m} and normal N_{n,m}.

This processing is carried out using 3D mesh modification software such as AUTOCAD (trade name).

The result of this processing is a photorealistic 3D volume corresponding to the person whose image was acquired during the acquisition phase.

The enveloping texture has a resolution adapted to the intended use (e.g., a 3D printing).

The processing result is recorded in a transfer format, for example, the OBJ format.

### Second Alternative: Recalculation of the Creation of the Avatar Topology.

Another application involves creating a 3Davatar from the 3D mesh obtained during the step of photogrammetry.

For this purpose, a model mesh MM recorded in OBJ format is used, organized in groups of areas of interest corresponding to subsets of polygons corresponding to significant parts, for example, the group of polygons corresponding to the mouth, a finger, a breast, an arm, etc. Each significant subgroup is associated with an identifier, and possibly with markers corresponding to particular treatments when creating an avatar (e.g., “dressing” treatment). The same polygon can belong to several subgroups.

The model mesh MM can optionally be processed by calculating a deformed model MMD, retaining the same subsets of polygons and identifiers, but with local deformations of some polygons, to create, for example, the model MMD of a muscular man from a standard male model MM.

To create an avatar corresponding to the selected model MM from the crude mesh MBI, a retopology calculation is performed.

This calculation requires the identification of the characteristic points of the crude mesh MBI that will be matched with corresponding characteristic points of the model mesh MM.

For this purpose, singular points previously identified on the model mesh MM are determined on the crude mesh, for example, the corner of the eye, the corner of the mouth the fingertips, etc.

Then a treatment is applied that includes deforming the model mesh MM to locally match each singular point with the position of the associated singular point on the crude mesh MBI, and recalculate the position of each of the characteristic points of the model mesh MM, by a 3D morphing software.

The result of this treatment is a mesh MMI recorded in OBJ format, corresponding to the adaptation of the model to the morphology of the original person.

This mesh MMI is used to create a complete animation skeleton.

This skeleton is created from the mesh MMI and control points, on the mesh, corresponding to the articulations of the digital skeleton and the association of these control points with the articulation points of the skeleton.

The additional elements (the teeth, the tongue, the eye orbit) from a library of elements are then positioned on the avatar thus created, taking into account the above-mentioned subgroups.

A skinning process is then applied to associate each characteristic point with a portion of the skin of the object to be animated, however a given portion of the skin can be associated with several bones, according to a precise weighting and this information is recorded in a numerical file.

### Applications

Embodiments of the present disclosure make it possible to create three-dimensional photorealistic representations for various applications such as fitness, to design one's ideal, more muscular and/or thinner, body, based on reference models MM, merged with the crude mesh MBI of an actual physical person. This representation can be shown to a coach to do a customized training program in order to look like one's avatar in the near future.

The periodic acquisition of photorealistic representations makes it possible to check the progress achieved and the effort required to reach the objective.

This allows the user to set a visible and measurable objective to “sculpt” his or her body.

The applications also relate to the field of cosmetic surgery to visualize the postoperative result and use it as a support for a consultation with a surgeon.

It enables a decision to be made in front of the practitioner with a result beforehand.

Another application relates to the field of ready-to-wear clothes (online fitting before purchase), by offering the possibility to dress your avatar with a designer's collection and see yourself modelling the clothing, to virtually try on the clothes before purchase, and zoom in to observe all the details of the clothes worn (sizes, necessary alterations, colors, etc.).

1. A method for creating a three-dimensional virtual representation of a person comprising the steps of:
a) acquiring a plurality of images of a person located in a reference position in an imaging cabin, the acquiring of the plurality of images comprising recording a series of at least eighty simultaneous images using image sensors distributed across an inner surface of a closed ovoid-shaped cabin having an access door, the image sensors being distributed in a homogeneous manner with respect to an axis of symmetry of the cabin; and
b) calculating by photogrammetry, a crude mesh of the actual person.

2. The method of claim 1, wherein a photosensitive surface of the image sensors has a size of less than 25×25 millimeters.

3. The method of claim 2, wherein the inner surface of the cabin has non-repetitive contrast patterns, the method further comprising at least one step of calibration comprising acquiring a session of images of the cabin without a person being present, and wherein the step of photogrammetry comprises a step of calculating an ID image by subtracting the acquired image in the presence of a person in the cabin and the calibration image corresponding to the same image sensor.

4. The method of claim 3, wherein the step of photogrammetry includes the steps of creating a cloud of 3D points by extracting, in each of the close-cut images IDᵢ, of the characteristic points PCᵢⱼ and recording the coordinates of each of the characteristic points PCᵢⱼ and building the crude mesh from the characteristic points PCᵢⱼ thus identified and calculating an envelope texture.

5. The method of claim 4, wherein a 3D mesh and texturing obtained from the photogrammetry are subjected to an additional smoothing treatment.

6. The method of claim 5, further comprising an additional step of merging the crude mesh with a model mesh MM organized in groups of areas of interest corresponding to subsets of polygons corresponding to significant parts, to be determined on the crude mesh corresponding to singular points previously identified on the model mesh MM, and then applying a treatment including deforming the mesh of the model MM to locally match each singular point with the position of the associated singular point on the crude mesh MBI, and recalculating the position of each characteristic point of the mesh of the model MM.

7. The method of claim 6, further comprising a step of transforming the crude mesh into a standardized mesh comprising an automatic identification of a plurality of characteristic points of the human body on the crude mesh, by processing for the recognition of elements recorded in a library of points of interest in a table format associating a digital label with a characterization rule.

8. An image shooting cabin, comprising:
a closed structure having an access door, the closed structure having an ovoid inner shape; and
a plurality of image sensors oriented toward the inside of the closed structure, the plurality of image sensors including at least eighty image sensors homogenously distributed over an inner surface of the closed with respect to the axis of symmetry of said cabin.

9. The image shooting cabin of claim 8, wherein each image sensor of the plurality is smaller than 25×25 millimeters.

10. The image shooting cabin of claim 9, wherein a cross-section of the closed structure has a maximum diameter between two meters and five meters.

11. The image shooting cabin of claim 9, wherein a cross-section of the closed structure has a maximum diameter of two meters or less.

12. The method of claim 1, wherein the inner surface of the cabin has non-repetitive contrast patterns, the method further comprising at least one step of calibration comprising acquiring a session of images of the cabin without a person being present, and wherein the step of photogrammetry comprises a step of calculating an ID image by subtracting the acquired image in the presence of a person in the cabin and the calibration image corresponding to the same image sensor.

13. The method of claim 1, wherein the step of photogrammetry includes the steps of creating a cloud of 3D points by extracting, in each of the close-cut images IDᵢ, of the characteristic points PCᵢⱼ and recording the coordinates of each of the characteristic points PCᵢⱼ and building the crude mesh from the characteristic points PCᵢⱼ thus identified and calculating an envelope texture.

14. The method of claim 1, wherein a 3D mesh and texturing obtained from the photogrammetry are subjected to an additional smoothing treatment.

15. The method of claim 1, further comprising an additional step of merging the crude mesh with a model mesh MM organized in groups of areas of interest corresponding to subsets of polygons corresponding to significant parts, to be determined on the crude mesh corresponding to singular points previously identified on the model mesh MM, and then applying a treatment including deforming the mesh of the model MM to locally match each singular point with the position of the associated singular point on the crude mesh MBI, and recalculating the position of each characteristic point of the mesh of the model MM.

16. The method of claim 6, further comprising a step of transforming the crude mesh into a standardized mesh comprising an automatic identification of a plurality of characteristic points of the human body on the crude mesh, by processing for the recognition of elements recorded in a library of points of interest in a table format associating a digital label with a characterization rule.
